(19) United States
(12) Patent Application Publication
(10) Pub. No.: US 2017/0268948 A1
(43) Pub. Date: Sep. 21, 2017

(54) SYSTEM AND METHOD FOR ANALYSING THE ENERGY EFFICIENCY OF A VEHICLE

(71) Applicant: AVL LIST GMBH, Graz (AT)

(72) Inventors: Helmut LIST, Graz (AT); Peter SCHOEGGL, Hitzendorf (AT); Guenter Karl FRAIDL, Graz (AT); Erik BOGNER, Graz (AT); Mario OSWALD, Fernitz (AT)

(21) Appl. No.: 15/307,426

(22) PCT Filed: Apr. 30, 2015
(86) PCT No.: PCT/EP2015/059551

§ 371 Date: Oct. 28, 2016

(30) Foreign Application Priority Data
Apr. 30, 2014 (DE) 10 2014 006 322.4

(51) Int. Cl. G01L 5/13; G01M 17/007

(52) U.S. Cl. CPC G01L 5/13; G01M 17/007

(57) ABSTRACT

A system for analysing an energy efficiency of a vehicle having at least one drive device which is configured to generate mechanical drive force by converting energy, wherein the system has a first device, in particular a sensor, configured for detecting a first data record of at least one first parameter which is suitable for characterizing energy which is consumed by the vehicle, a second device, in particular a sensor, configured for detecting a second data record of at least one second parameter which is suitable for characterizing a driving resistance which the vehicle overcomes, a third device, in particular a sensor, configured for detecting a third data record of at least one third parameter which is suitable for characterizing at least one driving state of the vehicle, a first comparison device, which is in particular part of a data processing device, configured for comparing the values of the third data record with predefined parameter ranges which correspond to at least one driving state, an assignment device (8), which is in particular part of a data processing device, configured for assigning the values of the first data record and the values of the second data record to the respectively present at least one driving state, and a processing device, which is in particular part of a data processing device, configured for determining at least one characteristic value which characterizes the energy efficiency of the vehicle, on the basis of the first data record and of the second data record as a function of the at least one driving state.

The invention relates to a system and a method for analyzing an energy efficiency of a vehicle having at least one drive device which is configured to generate mechanical propulsion by converting energy. The invention further relates to a method for analyzing the operating behavior of a vehicle.

The energy efficiency of vehicles is increasingly gaining in importance, both as a selling point for customers against the backdrop of increasing energy costs as well as for legislators against the backdrop of needing to reduce vehicle environmental pollution in the context of climate protection objectives.

On the consumer side, the overall total costs of vehicle ownership is also becoming increasingly important. Additionally, purely subjective criteria such as social trends and social acceptance, etc., but also particularly a “positive driving experience” are having increasing influence on the most critical of purchase factors. Thus, the focus of representation is expanded from purely technical objective values such as performance and fuel consumption to the satisfying of a positive subjective customer experience, the “experience car.” The consumers thereby perceive the properties and value of the vehicle such as its design, ergonomics, operability, infotainment and assistance systems, sense of safety, emissions, NVH level, agility, performance, energy efficiency and driveability in a holistic context as the overall vehicle operating behavior.

In terms of the purely technical aspects, CO₂ legislation certainly represents the most substantial technology driver. Future CO₂ and/or fuel economy fleet limits are globally converging to continuously reducing levels. On the one hand, this necessitates complex drive systems with highly versatile components but, on the other hand, it also requires heightened individualized adaptation to very different boundary conditions, resulting in multi-dimensional diversification of the drive systems (different energy sources, different degrees of electrification, high diversity, etc.).

In the future, the integrating of the vehicle's powertrain into the overall vehicle environment (i.e. connected powertrain) will also allow for optimally adapting control strategies to the real-world traffic and environmental conditions, in particular the topography. The abundance of information from in-vehicle infotainment and driver assistance systems to vehicle-to-vehicle communication (Car2Car) or vehicle-to-X communication (Car2X) enables the calculating of many scenarios in advance and thus vastly expanding the optimization horizon. There is thus the possibility of utilizing the wide flexibility of future drive systems to a substantially higher degree to reduce energy consumption. However, this requires highly complex control strategies with dramatically increased development, calibration and, above all, validation expenditures.

Energy efficiency, emission, driveability and NVH level (Noise/Vibration/Harshness) criteria have proven to play a prominent role in terms of customer satisfaction and compliance with regulatory conditions. This list is not, however, conclusive and other criteria as noted above may also gain importance as a result of future developments.

EP 0 846 945 A2 relates to a method for analyzing motor vehicle driving behavior. An analysis of a motor vehicle's driveability can be measured on a test stand with little effort by performing the following steps: Taking measurements of an actual vehicle to obtain measurement variables for the driving behavior, deriving at least one evaluation variable which expresses the driveability of the vehicle as a function of one or more measurement variables, preparing a simulation model to represent dependencies between the individual measurement variables and in particular to calculate the evaluation variable from a set of predefined measurement variables which can be determined both on the actual vehicle as well as on a test stand, and calibrating a dynamic test stand on the basis of the simulation model.

U.S. Pat. No. 7,523,654 B2 relates to a method and an apparatus for evaluating the NVH characteristics of a mechanical system having a torque-transmitting assembly comprising drive and driven elements which interact in a driving manner.

DE 10 2009 048 615 A1 relates to a method for the electronic configuration of motor vehicles, wherein
a route-dependent driving profile is determined for the vehicle to be configured,
the expected energy influences on the vehicle are simulated and quantified based on the driving profile,
separate, mutually compatible function blocks of the vehicle are determined dependent on the energy influences expected in the vehicle, wherein the function blocks in particular characterize energy properties of a component contained within the respective function block,
the separate function blocks are compiled and a driving profile-dependent total or partial energy balance is generated,
individual function blocks for the optimization of the total/partial driving profile-dependent energy balance and/or the creating of variants are exchanged or replaced until an energy-efficient vehicle results for the desired driving profile.

WO 2014/062127 A1 relates to a system for using operational data from at least one vehicle which comprises:
a collection device designed to collect the operational data, wherein the operational data comprises information on how the at least one vehicle has been used;
a calculation device designed to determine an energy consumption c in the form of an energy consumption matrix for the at least one vehicle as a function of engine speed and torque for a powertrain in the at least one vehicle based on the operational data;
and a utilization device designed to utilize the energy consumption c.

US 2007/01 12475 A1 relates to a device for managing a motor vehicle's power consumption comprising a power management logic which is suited to calculating an applied power for the vehicle engine based on information on the vehicle's environment, information on the operating status of the vehicle, one or more control inputs and one or more operating parameters of the vehicle.

U.S. Pat. No. 8,571,748 B2 relates to a method for estimating a propulsion-related operating parameter of a vehicle for a road segment, wherein the method comprises:
estimating at least one operating parameter of the vehicle for the road segment based on information on said road segment;
estimating the propulsion-related operating parameter for the road segment using the at least one estimated operating parameter and at least one vehicle-specific parameter, wherein the at least one vehicle-specific parameter is determined by:
acquiring driving data to determine a plurality of vehicle operating parameters while the vehicle is in operation;
using at least two of the determined vehicle operating parameters in a predetermined relationship which includes the at least one vehicle-specific parameter; and
determining the at least one vehicle-specific parameter from the driving data for the at least two vehicle operating parameters and the relationship,
identifying different driving phases in the driving data acquired on the plurality of vehicle operating parameters, wherein at least one vehicle-specific parameter is determined for the driving phases, wherein each identified driving phase is associated with a set of vehicle-specific parameters determined from the respective driving data, wherein the vehicle-specific parameters determined for all the driving phases identified are used to estimate the propulsion-related operating parameter.

In order to give consumers a point of reference with respect to energy efficiency, the regulation on identifying passenger car CO2 emissions has been in force in the Federal Republic of Germany since Dec. 1, 2011. Since then, any vehicle on display or offered for sale or lease must display the associated CO2 label identifying its energy efficiency class. For vehicles, this classification is based on the vehicle's weight. There is thereby a direct connection between a vehicle's energy efficiency and its emissions.

In order to classify vehicles into energy efficiency classes, the reference value for the CO2 emission is determined, at the time of application, based on the vehicle weight. In contrast, information on how much of the energy that goes into effecting the forward movement of a vehicle is used efficiently and how much the individual apparatus A of the vehicle such as the powertrain, steering, drive device or even the auxiliary equipment or other influencing factors contribute to the energy efficiency cannot be deduced from the classification into an energy efficiency class.

Emissions are also subject to ever stricter legal regulations. The European Community's first uniform emission standards came into force in 1970. At that time, only carbon monoxide and hydrocarbon emissions were limited. Nitrogen oxide was introduced as an additionally restricted exhaust emission in 1977. Limit values on particulate matter (soot) from diesel engines were introduced in 1988. Europe-wide limit values on exhaust emissions for commercial vehicles and buses were first established in 1988. Europe-wide exhaust limits have been in place for motorcycles and mopeds since 1997.

Exhaust regulations have gradually intensified ever since. The strictness here pertains to the type and amount of emission values and the continuing compliance with same.

Consumption and emission value testing to the regulatory standards are tested in a likewise standardized driving cycle. This has been the accepted method for decades for determining emissions during approval testing of vehicles on the test bed. In a laboratory environment with clear underlying temperature, fuel, test cycle and/or route profile conditions, the engines and vehicles are optimized in terms of minimum exhaust emissions and fuel consumption. With improved combustion processes and utilization of appropriate exhaust gas treatment, the values remain below all the legal emission limits at the time of application. The current New European Driving Cycle at the time of application lasts a total of 1180 seconds (just under 20 minutes). It consists of an Urban cycle (urban conditions) lasting for 780 seconds and an Extra-urban cycle (inter-urban conditions) lasting for 400 seconds. The ambient temperature during the test is 20° C. to 30° C. Cold-start conditions, acceleration and lag are determined and interpolated accordingly.

The evaluation of consumption and emissions on the basis of the standardized driving cycle represents an averaged profile enabling comparison of different vehicles. The driving cycles usually only partly correspond to the individual customer usage profiles, particularly when a customer regularly drives in heavy city traffic or only for short distances. The process also does not measure, and thus does not incorporate into the average calculation, consumption or emissions at speeds greater than 120 km/h. During a driving cycle, the search for causes of increased emissions strives for an optimization of the entire cycle.

One task of the invention is providing a system and a method which enables a generally applicable analysis of a vehicle's energy efficiency. In particular, the analysis should not be dependent on, or only to a minor extent, the vehicle weight or the driving cycle as driven.

This task is solved by a system in accordance with claim 1 for analyzing a motor vehicle's energy efficiency, by a corresponding method in accordance with claim 6, and by a method in accordance with claim 13 for analyzing a vehicle's operating behavior. Advantageous embodiments of the inventive teaching are claimed in the subclaims.

The invention is based in particular on the approach of segmenting complex driving processes into separate driving elements and/or driving states or sequences of driving states and determining a characteristic value on the basis of the segmentation. The applicant has determined that significant efficiency improvements for vehicles can be achieved by means of such a segmented analysis of the vehicle's energy efficiency when optimization is based on such a characteristic value.

The invention is further based in particular on the approach that not only the energy efficiency of a vehicle but also further criteria have a substantial impact on the subjective perception of the vehicle by a driver or by vehicle passengers respectively. Therefore, a characteristic value should additionally be determined for the operating behavior of the vehicle. It is thereby of importance to identify individual driving elements and/or driving states which are of particular relevance to the individual criteria, whereby these properties are given a higher weighting with the respective driving elements than properties in which the respective driving element is not as relevant. A characteristic value for the operating behavior of the vehicle is thereby output as a result.

Determining such generally applicable characteristic values enable a vehicle certification to ensue from measurements during actual vehicle operation independent of specific driving cycle. This leads to a substantially better comparability of vehicles of different vehicle classes and to results which better represent consumption in actual traffic. Moreover, the controllable testing area of the test bed is broadened by the partly stochastic road travel (real-drive) component; i.e. an expanding of the synthesized test cycle by the random real-world operation with a vast number of different driving elements and boundary conditions.

Consumption, emissions and the efficiency can be inventively analyzed with respect to individual driving states, a plurality of similar driving states and/or sequences of different driving states of the vehicle so as to reveal the influences of driving states on the energy efficiency and the vehicle's operating behavior.

A drive device within the meaning of the invention is designed to convert energy in order to generate mechanical propulsion.

The term “acquire” within the meaning of the invention includes importing data sets produced in particular by simulations, simulating an operating state of a vehicle power unit and/or taking measurements on a vehicle or on a test bed.

Within the meaning of the invention, a driving state is defined by a value or a plurality of values of a parameter or a combination or plurality of combinations of values of multiple parameters, depending on whether the driving state is considered situational (for example, during cornering) or whether a driving state only evolves from a parameter over time (for example, upon tip-in). A driving state within the meaning of the invention in particular reflects the vehicle's driving dynamics. Driving states are in particular rolling at constant speed, acceleration, cornering, parking, straight-line driving, idling (coasting), tip-in (sudden depression of acceleration), let-off (sudden release of acceleration), constant speed, shifting, standstill, ascending, descending, electric powered, recuperative braking, mechanical braking, or also a combination of at least two of these driving states. With some of the driving states, driving dynamics is also determined by the type of drive or by the operating state of vehicle components. Hence, in the case of a full hybrid vehicle, three different tip-in driving states are in principle possible, a tip-in driven by the internal combustion engine, a tip-in driven by the electric motor, and a tip-in in which the electric motor is used as added electric boost. Single driving states can be refined down to consideration of separate combinations such that tip-ins in different gears or of different output speeds, for example, can also be distinguished as different driving states.

Driving resistance as defined by the invention denotes that sum total of the resistances which a ground vehicle needs to overcome by way of propulsion in order to travel a horizontal or inclined plane at a constant or accelerating speed. The components of driving resistance are in particular aerodynamic drag, rolling resistance, climbing resistance and/or acceleration resistance.

Topography in the sense of the invention is a terrain and indicates in particular the inclination of the road surface, the curving of a road, and altitude above sea level.

As defined by the invention, an apparatus A of a vehicle is a structural element, particularly auxiliary equipment, a component, particularly power electronics, or a drive device or a system, particularly a steering system or powertrain.

A driving element in the terms of the invention is preferably a driving state. Further preferably, the development of additional parameters which characterize the initially specified criteria can be taken into account in the identifying of a driving element. It is thereby for example conceivable for an increase of the first parameter, which characterizes the vehicle's energy consumption, to indicate a particularly relevant driving element for the energy consumption and thus for the energy efficiency.

Real-drive within the meaning of the invention means actual vehicle operation, particularly on the road or over terrain. In the case of semi-simulated or fully simulated vehicles, real-drive can also denote the representation of such actual travel on a test bed, for example via stochastic methods. Real-drive emissions are accordingly produced during (simulated) real travel; real-drive efficiency is the energy efficiency of the vehicle during (simulated) real vehicle operation.

In an advantageous embodiment of the inventive system, same comprises a fourth device, particularly an interface, designed to acquire a target value for the at least one characteristic value, particularly on the basis of a vehicle model or a reference vehicle, a second comparison device, particularly part of a data processing device, designed to compare a characteristic value to the target value, and an output device, particularly a display, designed to output an evaluation of the energy efficiency on the basis of the comparison.

The evaluation of the energy efficiency allows easily comparing different vehicles with one another.

In a further advantageous embodiment of the inventive system, same comprises a selection device, in particular as part of a data processing device, designed to appoint at least one apparatus A, the energy consumption of which is not factored into the determining of the at least one characteristic value for the energy efficiency of the vehicle, and a fifth device, particularly a sensor, which is in particular designed to acquire a further second parameter characterizing the energy consumption of the at least one apparatus A, wherein the processing device is further designed to adjust the energy consumption of the vehicle and the energy consumption of the at least one apparatus A.

In addition to segmenting complex driving profiles into small, assessable single elements, this categorizing of the system integration of the complete vehicle into different system and component and even structural element levels (horizontal categorization) is also a reliable basis for efficient development processes.

By adjusting the energy consumption of the vehicle by the energy consumption of an apparatus A, the analysis of the energy efficiency can be focused on specific functions of the vehicle or the components or systems of the vehicle respectively. For example, all the apparatus A not contributing to the driving of the vehicle, e.g. all the comfort functions, can thereby thus be suppressed. By so doing, the efficiency of e.g. the powertrain can be determined. Further preferably, all the apparatus A which are, for example, not a part of the vehicle's steering system can be suppressed. By so doing, the energy efficiency of the steering system can be selectively analyzed.

In a further advantageous embodiment of the inventive system, same further comprises a storage device designed to store a sequence of driving states and the processing device is further designed to factor in the sequence of driving states when determining the characteristic value.

This realization of the inventive system enables not only determining values on the basis of single driving elements, particularly driving states, but also allows for factoring in the influence which preceding and/or subsequent driving states have on the current driving states to be evaluated. Additionally, characteristic values can also be determined over measuring periods encompassing multiple driving states, wherein the respective parameters used for the analysis can be consolidated or integrated over these periods.

In one further advantageous embodiment of the inventive system, the processing device is furthermore designed to adjust an allocation of the values of the first data set and the second data set to the at least one defined driving state so as to take into account signal propagation delay and/or elapsed time from at least one measuring medium for acquiring the respective data set to a sensor.

This embodiment of the inventive system can prevent determined or measured values from being allocated to the wrong driving states or, respectively, elements being incorrectly identified.

In one advantageous embodiment of the inventive method, same further comprises the following procedural steps: acquiring a target value for the at least one characteristic value, particularly on the basis of a vehicle model or a reference vehicle, comparing the characteristic value to the target value, and outputting an evaluation of energy efficiency on the basis of the comparison.

The target value calculation is preferably realized in a complete vehicle model synchronized to the vehicle measurements based on the measured vehicle lateral dynamics and a factoring in of the current topography as well as the driving resistances. The vehicle model preferably not only contains the entire hardware configuration but also the corresponding operating strategies. A balancing of all energy flows and energy stores is thereby preferably made.

The aspects of the invention described above and the associated features disclosed with respect to the further development of the inventive system also apply analogously to the aspects of the invention described below and the associated further development of the inventive method and vice versa.

In one advantageous embodiment, the inventive method further comprises the following procedural steps: acquiring a target value for the at least one characteristic value, particularly on the basis of a vehicle model or a reference vehicle, comparing the characteristic value to the target value, and outputting an evaluation of energy efficiency on the basis of the comparison.

In a further advantageous embodiment of the inventive method, the second parameter is further suited to characterizing an operating state and/or an energy consumption of at least one apparatus A of the vehicle, particularly an auxiliary equipment unit of the at least one drive device, steering system or powertrain and/or a topography of the vehicle's surroundings.

Particularly by determining the topography of the vehicle's surroundings, an operation strategy of the vehicle can be adapted to a change in course on the road which the vehicle is traveling prior to reaching the respective course of the road. Considerable gains in efficiency can be thereby be achieved.

In a further advantageous embodiment of the inventive method, the at least one second parameter is further suited to characterizing an operating state and/or an energy consumption of at least one apparatus A of the vehicle, particularly an auxiliary equipment unit of the at least one drive device, steering system or powertrain and the inventive method further comprises the procedural steps: appointing the at least one apparatus A, the energy consumption of which is not to be factored in when determining the at least one characteristic value on the energy efficiency of the vehicle, and adjusting the energy consumption of the vehicle by the energy consumption of the at least one apparatus A.

As described with respect to one advantageous embodiment of the inventive system, the efficiency of the complete vehicle can thereby also be broken down into the efficiency of the system, a component or even a structural element of the vehicle.

In a further advantageous embodiment of the inventive method, the at least one apparatus A is necessary to the vehicle's drive operation or fulfills a function independent of the operational drive.

Apparatus A necessary to the vehicle's drive operation are for example all the components of the powertrain or also the legally stipulated apparatus A such as the light system, braking system or active safety devices. Functions independent of the drive operation are primarily comfort functions, in particular those which, for example, provide the climate control or the infotainment.

In a further advantageous embodiment of the inventive method, the at least one drive device is an internal combustion engine or an electric motor having a fuel cell system and the first parameter indicates at least one emission of the internal combustion engine or fuel cell system.

According to this embodiment, the energy consumption of the vehicle can be determined by measuring emission, particularly the CO₂ emission. Preferably, the energy supply and energy drain of an energy storage device is also taken into account in the process.

In a further advantageous embodiment of the inventive method, the at least one parameter is additionally suited to characterizing an emission, driveability and/or an NVH level of the vehicle and the method further comprises the following procedural step: selecting at least one operating mode of the vehicle on which the evaluation additionally depends from among one of the following operating modes: efficiency-oriented operating mode, reduced-emission operating mode, driveability-oriented operating mode, NVH-optimized operating mode.

In a further advantageous embodiment of the inventive method, the procedural steps continue until the third data set spans a plurality of different driving states.

In a further advantageous embodiment, the inventive method further comprises the following procedural step: determining the sequence of the driving states, whereby the sequence of driving states is taken into account in the determining of the characteristic value.

As previously described with respect to one advantageous embodiment of the inventive system, the influence driving states have on each other can thereby be taken into account.

In a further advantageous embodiment of the inventive method, the values of the first data set and/or the second data set are integrated over the duration of the respective vehicle operating state.

This integration or consolidation respectively of the values enables determining a characteristic value over the total duration of a driving state.

In a further advantageous embodiment, the plurality of third data sets can be consolidated in the determining of the at least one characteristic value for the same type of driving state.

A statistic evaluation of identical driving states can thereby be made.

In a further advantageous embodiment, the inventive method further comprises the following procedural step: adjusting an allocation of the values of the first data set and the second data set to the at least one predefined driving state so as to take into account a signal propagation delay and/or an elapsed time from at least one measuring medium for acquiring the respective data set to a sensor.

In a further advantageous embodiment of the inventive method, the parameters of the data sets are measured during real-drive operation of the vehicle, wherein it is preferential for the vehicle to travel an actual driving route selected pursuant to stochastic principles, more preferential for a real vehicle to travel an at least partly simulated route selected pursuant to stochastic principles, even further preferential for an at least partly simulated vehicle to travel an at least partly simulated route selected pursuant to stochastic principles, and most preferential for a simulated vehicle to travel a simulated route selected pursuant to stochastic principles.

As defined by the invention, a real-drive operation of a vehicle is vehicle operation from the perspective of an operator's actual everyday driving, for example driving to work, shopping or to a vacation destination.

The method according to the invention enables disassociating test operation from driving cycles, wherein characteristic values are determined as a function of individual driving elements, particularly driving states. On the basis of this information, any driving cycle which represents real-drive operation of a vehicle can be formulated.

In one further advantageous embodiment of the inventive method, a characteristic value is only determined in the presence of at least one predefined driving state and/or when the first data set or the second data set meets predefined criteria.

This enables the relevant driving state selection or the relevant driving elements selection respectively for the determining of a characteristic value or an evaluation.

In a further advantageous embodiment of the inventive method, the measured values of a plurality of second data sets are consolidated in the determining of the at least one characteristic value for the same driving state type.

The inventive method can be used both to evaluate a real vehicle as well as to evaluate a partly simulated/emulated or fully simulated/emulated vehicle. In the real vehicle case, same is subjected to real operation and the parameters which form the data sets determined by sensor measurements.

In the partly simulated case, a simulation model is created for the entire vehicle with its parameter values for at least one parameter of a data set calculatively determined. The tests are in particular conducted on test beds, whereby parameter values are determined for those parameters or data sets respectively for which measurements are possible, preferably by means of a measurement.

In the case of a fully simulated evaluation, the entire vehicle is simulated and the test operation occurs entirely as a simulation without a test bed, whereby measured parameter values for individual vehicle components or systems can be incorporated into the simulation. When evaluating a real vehicle, the real vehicle can be operated both in traffic and off-road or also on a simulated route and/or simulated terrain on the roller test rig. In accordance with these possibilities of using the inventive system and the inventive method for evaluating a real vehicle based on a full or semi-simulation of the vehicle, the term “acquire” as defined by the invention means importing data sets generated in particular by simulation, indicating an operating state of a power unit of a real or simulated vehicle, and/or conducting measurements on real vehicles or on components or systems of a real vehicle on a test bed.

Further advantages, features and possible applications of the present invention will follow from the description below in conjunction with the figures. Shown are:

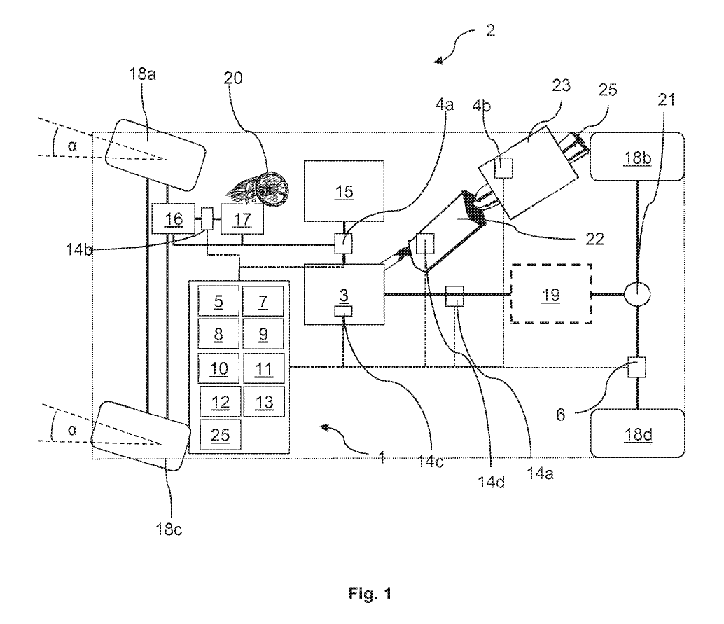

FIG. 1 a partly schematic depiction of a vehicle comprising an embodiment of the inventive system for evaluating and/or optimizing the energy efficiency of a motor vehicle;

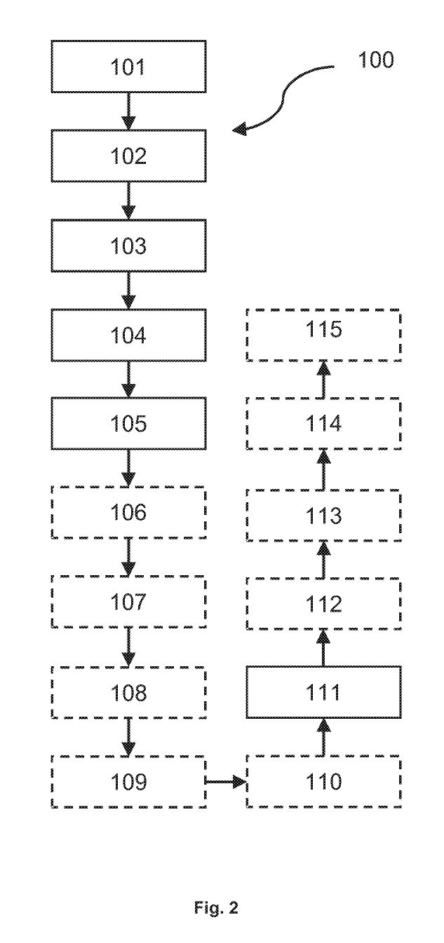

FIG. 2 a partly schematic block diagram of the inventive method for analyzing the energy efficiency of a motor vehicle;

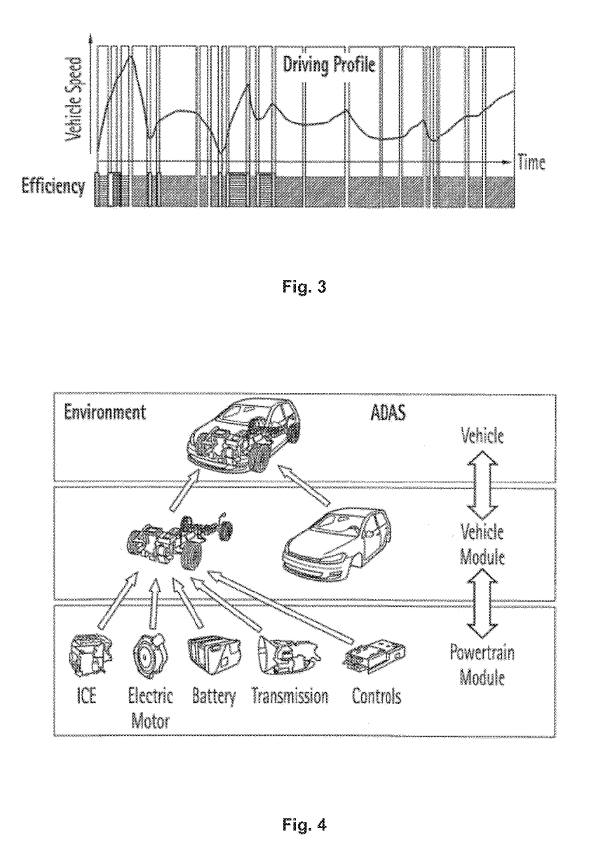

FIG. 3 a partly schematic diagram of a classification of the system integration of an entire vehicle pursuant to one embodiment of the inventive system and inventive method for analyzing the energy efficiency of a motor vehicle;

FIG. 4 a partly schematic diagram of a segmented driving profile of an embodiment of the inventive system and inventive method for analyzing the energy efficiency of a motor vehicle;

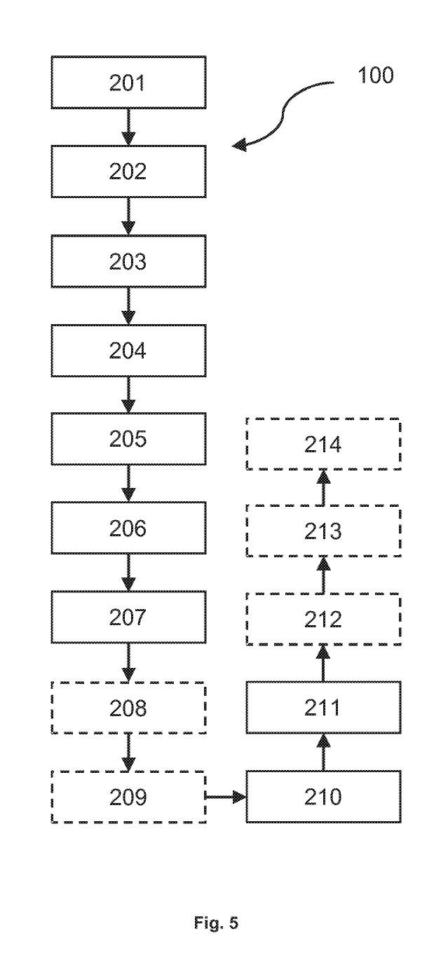

FIG. 5 a partly schematic block diagram of an embodiment of the inventive method for analyzing the operating behavior of a vehicle; and

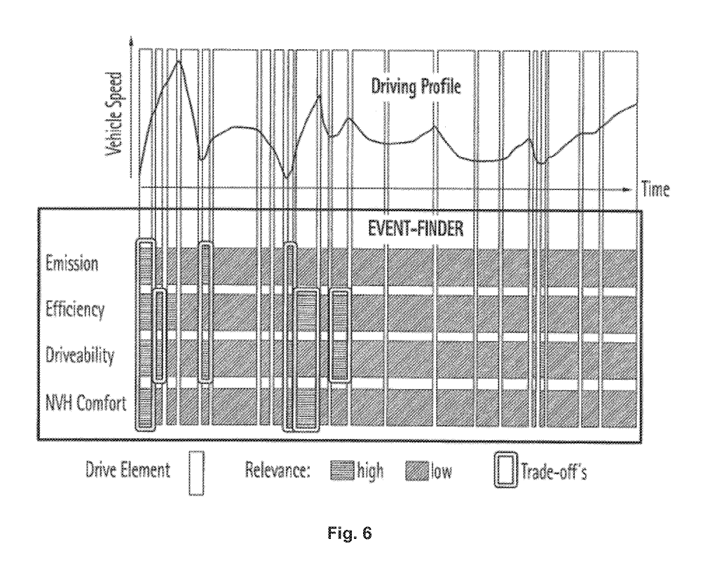

FIG. 6 a partly schematic diagram of a segmented driving profile according to an embodiment of the inventive method for analyzing the operating behavior of a vehicle.

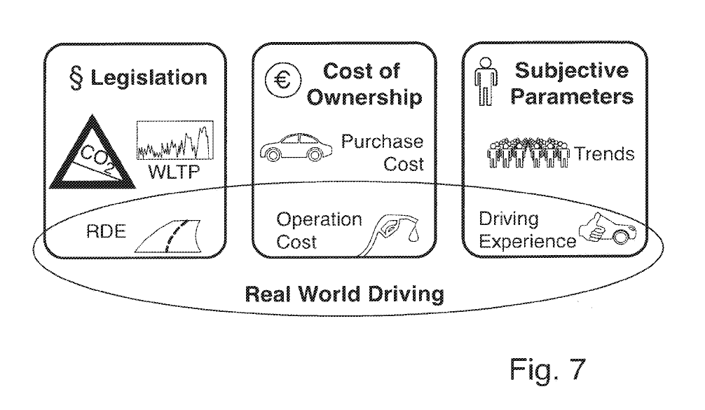

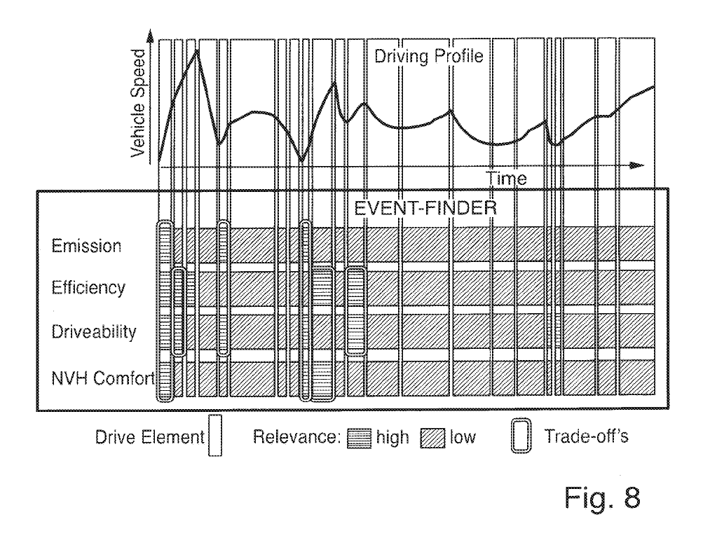

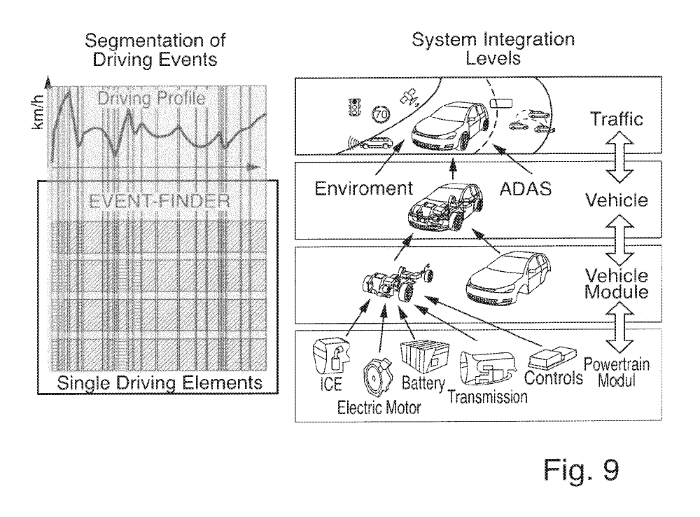

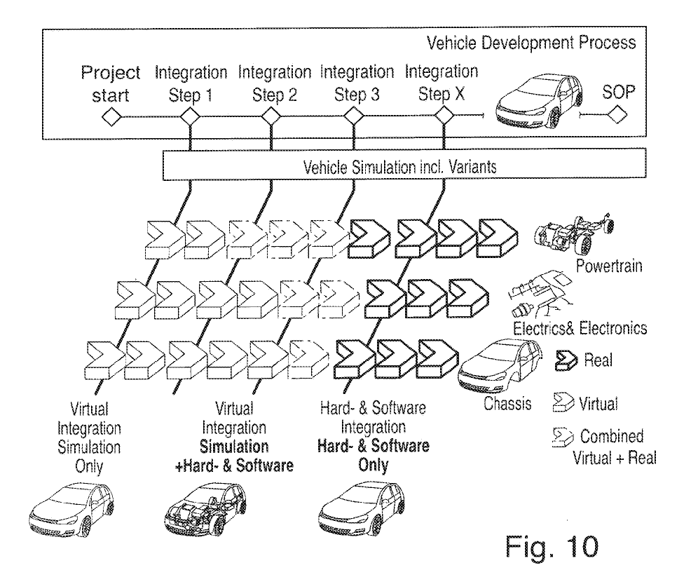

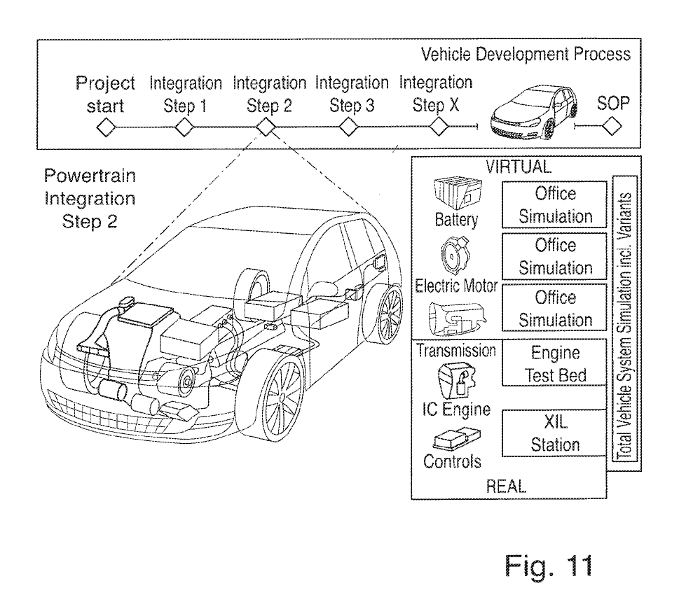

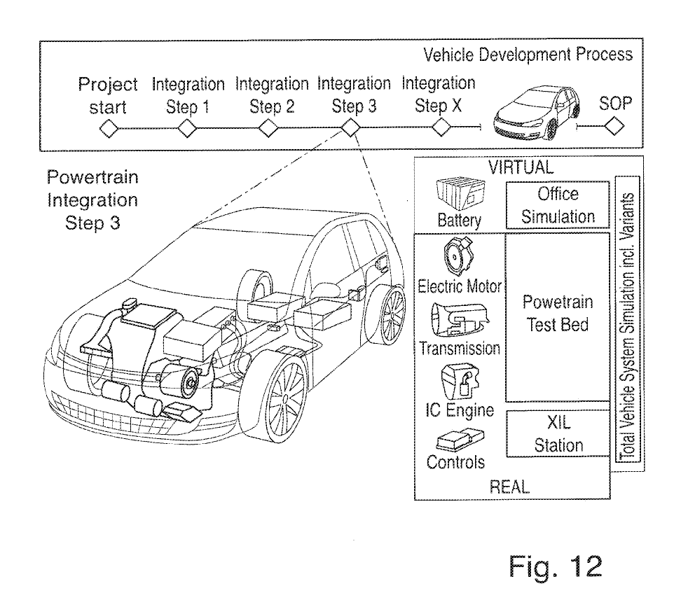

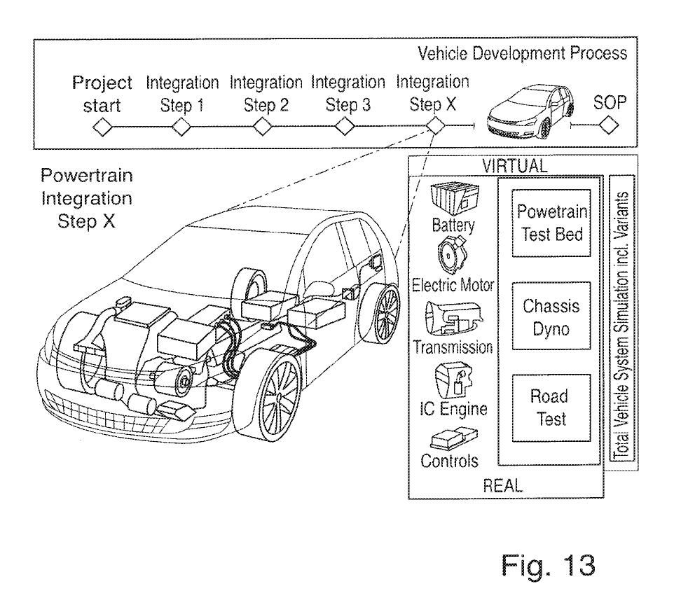

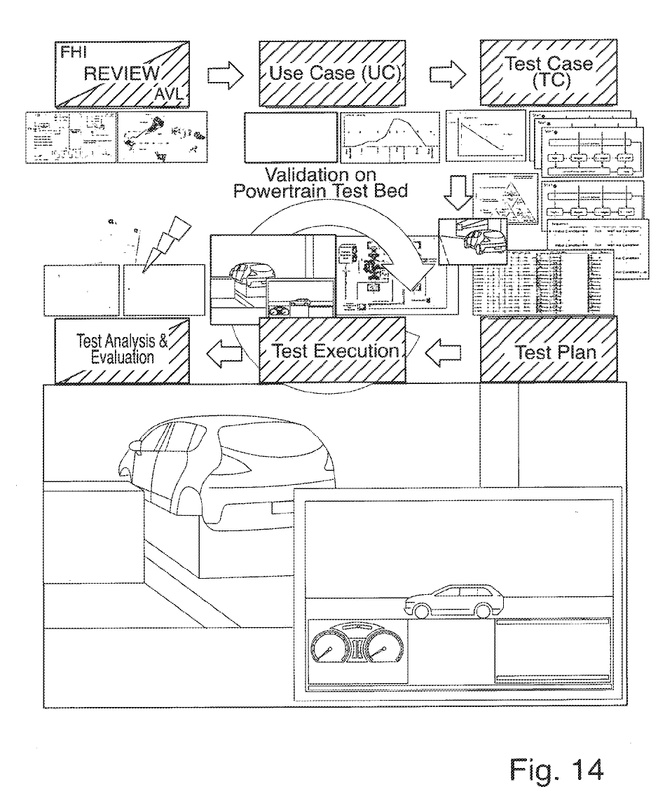

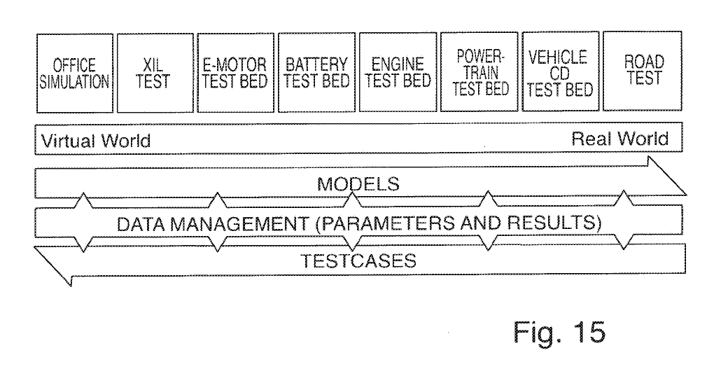

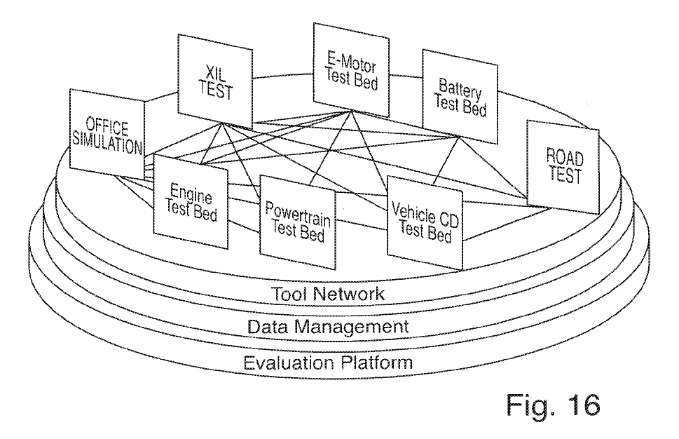

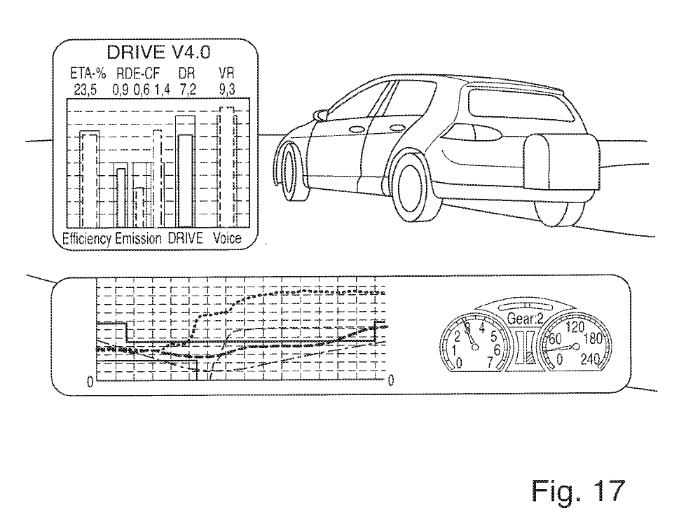

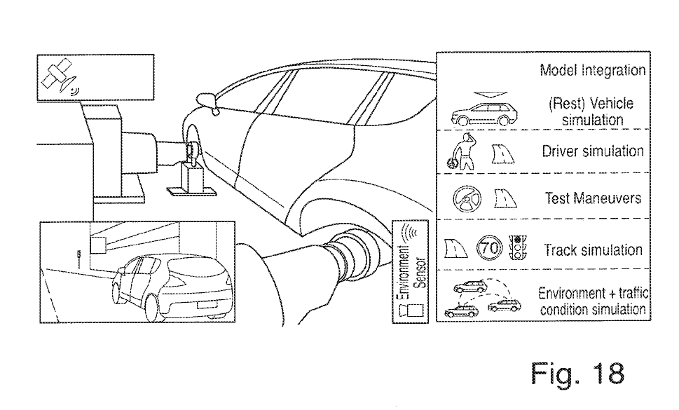

FIGS. 7 to 18 relate to further aspects of the invention.

FIG. 1 shows an embodiment of the inventive system in a vehicle 2 having a drive device 3 purely as an example. The drive device 3 is hereby in particular a component of the powertrain extending as applicable from the drive device 3 to the transmission 19 and a differential 21 via a drive shaft and then via axles on to wheels 18b, 18d, and also to further wheels 18a, 18c in a four-wheel drive. The drive device 3 is preferentially an internal combustion engine or an electric motor. The drive device can preferably also comprise a fuel cell system, particularly with a reformer and a fuel cell, or a generator with which energy from a fuel, particularly diesel, can be converted into electrical energy. The drive device 3 draws the energy from an energy storage device 15 which can in particular be configured as a fuel reservoir, or as an electrical energy store, but also as a compressed air reservoir. The drive device 3 converts energy stored in the energy storage device 15 into mechanical propulsion by way of energy conversion. In the case of an internal combustion engine, a transmission 19 and a differential 21 transmit the mechanical energy via drive shafts and the axle to the drive wheels 18b, 18d of the vehicle 2. A part of the energy stored in the energy storage device 15 is diverted as mechanical energy to auxiliary equipment directly or with a conversion step by the drive device 3. Auxiliary equipment is hereby in particular an air conditioning system or fan but also servomotors, e.g. for the window lifts or an electromechanical or electrohydraulic steering actuator 16 or brake force booster; i.e. any assembly which consumes energy but is not directly involved in generating the drive of the vehicle 1. Exhaust and/or emissions which may ensue from the operation of the drive device 3, for example from the fuel cell system or the internal combustion engine, are discharged to the environment by means of an exhaust gas treatment apparatus 22, e.g. a catalytic converter or a particulate filter, and by the exhaust system 23. Preferably, the vehicle 2 can also have two drive devices 3, in particular an internal combustion engine and an electric motor, whereby in this case, two energy storage devices 15, in particular a fuel reservoir and an electrical energy store, are also provided.

The invention can be used to analyze any other type of vehicle having a multi-dimensional drive system. In particular, the invention can be used with vehicles having parallel hybrid drive, serial hybrid drive or combined hybrid drive.

The objective of the invention is that of determining the total energy consumption of the vehicle, determining the energy required for propulsion and any additional functions, and ascertaining a generally applicable energy efficiency for the vehicle therefrom.

The following will reference FIG. 1 in describing the inventive system 1 provided for the above purpose in a real vehicle, whereby the data sets of the various parameters are preferably determined by measurements. However, in further embodiments, which are not depicted, it can preferably also be provided for parts of the vehicle 2 to be simulated or emulated and only effect some data sets on the basis of measurements of the vehicle's remaining real systems and components or the outputs of the emulators respectively. Further preferably, it can also be provided for the entire vehicle with all its components and systems to be simulated.

A multi-mass oscillator can be used as a simulation model for the vehicle, its parameters adapted to a specific vehicle or group of vehicles.

The system 1 with all its components can be disposed in the vehicle. With tests on a real vehicle 2 and with partly simulated tests, the components of the system 1 which are not needed for the measurement performed on the vehicle or the test object on a test bed can also be located at a different location, for example in a back-end or on a central computer respectively.

Furthermore, the energy efficiency analysis of a vehicle 2 is depicted in the embodiment shown in FIG. 1 with the steering and powertrain systems or, respectively, with their electromechanical or hydromechanic steering actuator 16, steering control 17 or the drive device 3 respectively, energy storage device 15 and transmission 19 components as applicable. It is however evident to one skilled in the art that the methodology of the invention can also be applied to further systems, components and structural elements of the vehicle 2 such as, for example, the braking system and any further drive mechanisms, etc. there might be.

In the embodiment depicted in FIG. 1, the drive device 3 is an internal combustion engine with an exhaust gas treatment 22 and an exhaust system 24. An energy storage device 15 consists of the electrical energy store; i.e. the battery of the vehicle, and the fuel reservoir. The energy which is drawn from this energy storage device is preferably determined by at least one sensor 4a. Further preferably, at least one emission can be determined by a sensor 4b on an exhaust analysis device 23. Particularly advantageously, this is representative of the energy used by the internal combustion engine 3. The exhaust analysis device 23 can hereby be arranged upstream or downstream of the exhaust gas treatment.

The system 1 preferably further comprises a second device 14 which is designed to depict the driving resistance of the vehicle 2 at the current moment. Such a second device 14 is preferably suited to determining all driving resistance components having an impact on the vehicle 2; i.e. the aerodynamic drag, the rolling resistance, the climbing resistance and/or the acceleration resistance. Preferably, the process draws on vehicle specifications such as the vehicle weight and the Cw value, which are available e.g. from the manufacturer. Other parameters which change with the temperature or the navigable condition can be determined by sensors. Aerodynamic drag thereby in particular addresses the Cw value, the frontal area of the vehicle and the speed, the rolling resistance addresses the resilience of the wheel, the tire pressure and wheel geometry, the road surface properties which can be ascertained e.g. from a database, as well as the condition of the road. Climbing resistance addresses in particular the vehicle weight and the slope, whereby a barometric or GPS altimeter can determine the slope for a Δ distance traveled. The acceleration resistance depends in particular on the mass and the acceleration of the vehicle 2.

The system 1 further comprises a third device, or at least one sensor 6 respectively, which enables determining at least one parameter which is representative of the driving state of the vehicle 2. At least one parameter from the following group of parameters is hereby applicable as the parameter: engine speed, throttle valve position or gas pedal position, vehicle speed, vehicle longitudinal acceleration, negative intake manifold pressure, coolant temperature, ignition timing, injected fuel quantity, λ value, exhaust gas recirculation rate, exhaust temperature, engaged gear and gearshift change. For example, in FIG. 1, the drive wheel 18d rotational speed is determined by means of an incremental encoder 6, whereby the vehicle speed is able to be concluded at which for example the rolling at constant speed driving state and differing acceleration states can be determined. The system 1 furthermore comprises an allocation device 8, which is in particular part of a data processing device and which can allocate the determined energy consumption of the vehicle and the driving resistance of the vehicle to the respective driving state present at the time of measuring the respective parameter values. The energy the vehicle 2 needs to provide in order to produce a specific performance dictated by the driver can preferably be concluded from the driving resistance which the vehicle 2 needs to overcome. By comparing this energy to be provided by the vehicle 2 to the energy consumption of the vehicle 2, which is preferably determined by the sensors 4a, 4b, a characteristic value for the vehicle's energy efficiency can be specified. This is preferably calculated by a processing device 9, which likewise is in particular part of a data processing device.

Preferably, the inventive system 1 comprises a further fourth device 10 able to acquire a target value for the at least one characteristic value. Preferably, this fourth device 10 is an interface with which corresponding target values can be imported, further preferably this fourth device 10 is a simulation device for a vehicle model which generates a target value for the at least one characteristic value. By means of a second comparison device 11, the system can preferably compare the target value to the characteristic value and then output to a display 12.

The system 1 preferably further comprises a selection device 13 with which a user can select whether or not, and with which system, which specific component or structural element should be left unconsidered when the at least one energy efficiency characteristic value of the vehicle 2 is determined. To this end, a further sensor 14a, 14b, 14d, 14d, determines the energy consumption of the system, component or structural element and the processing device 9 adjusts the energy consumption of the vehicle 2 by the energy consumption of the respective system. All the sensors 4a, 4b, 5a, 5b, 5c, 5d, 6 of the inventive system 1 are preferably connected to a data processing device which in particular comprises a first comparison device 7, an allocation device 8, a processing device 9, a data interface 10, a second comparison device 11 and an output device 12, by means of a data connection, particularly through the data interface 10. The data connections are depicted schematically in FIG. 1 by dotted lines.

Moreover, the system 1 preferably comprises a data storage unit 25 in which a succession of driving states and the associated further data can be stored.

Further preferably, the processing device 9, which particularly comprises a microprocessor having a working memory and further is in particular a computer, can factor in the sequence of driving states when determining the characteristic value and when allocating the respective data set to the driving state and can adjust the allocation for a signal propagation delay or an elapsed time between a measuring medium and a sensor.

The following will reference FIGS. 2, 3 and 4 in illustrating one embodiment of the method 100 according to the invention.

The inventive method serves in the analyzing of the energy efficiency of a vehicle 2 and particularly in the determining of a characteristic value and an evaluation which is generally valid and for example not based on any one specific driving cycle.

The approach on which the invention is based is that of a segmenting of complex driving profiles into assessable driving elements which in particular correspond to driving states and a categorizing of the system integration of the entire vehicle 2. For this, preferably the energy which the various energy storage devices 15 of the vehicle 2 draw for their operation is determined, 101. The driving resistance of the vehicle is further determined, 102, whereby in practice both measurements as well as parameter values from databases are hereby employed in order to determine that energy the vehicle 2 needs to supply for propulsion to overcome the driving resistance.

The driving state of the vehicle is furthermore determined, 103, 104, 105, whereby driving states hereby include rolling at constant speed, acceleration, cornering, parking, straight-line driving, idling, tip-in let-off, constant speed, shifting, overrun, standstill, ascending, descending or also a combination of at least two of these driving states.

Lastly, the energy the vehicle needs for propulsion is determined, preferably based on the driving resistance to be overcome. This energy can preferably be compared to the energy provided by the energy storage device 15 such that a reference point for the energy efficiency of the vehicle 2 can be indicated as a characteristic value subject to driving state. This segmentation by driving state allows the determination of efficiency to be disassociated from the previous procedures of determining a vehicle's energy consumption with standardized driving cycles. The calculated characteristic value indicates a generally applicable characteristic value for the entire vehicle as a whole, 111.

It is obvious to one skilled in the art that there is no mandatory sequence to the individual procedural steps of the inventive method as depicted. For example, the data sets (101, 102, 103) can thus be acquired simultaneously or also in a different sequence than as shown in FIG. 2.

FIG. 3 shows a partially schematic diagram of the result of an inventive segmenting of real-drive measurements with which an analysis was made of the energy efficiency criterion based on the driving elements, in particular driving states, as driven.

The third parameter for the determining of the vehicle state is depicted in the upper part of the diagram and is the vehicle speed over the time, which represents the driving profile of the vehicle 2. Identified driving elements are depicted in the lower part of the diagram to which characteristic values with respect to the energy efficiency of the vehicle 2 are discretely applied or for which an evaluation is made individually.

The efficiency of the vehicle is hereby not averaged over the entire driving profile from the beginning as is common in prior art methods. In the invention, individual driving states are identified and these driving states are associated with the respective driving resistance of the vehicle and the energy consumed in the driving state. A characteristic value expressing the energy efficiency of the vehicle in the tested driving state is calculated on the basis of this allocation.

The method 100 can be used in online operation with immediate display of the characteristic value. This is for example advantageous if the system 1 is fully installed in the vehicle 2 and a test driver wishes to call up information on the vehicle's energy efficiency or performance during a test drive. The method 100 can however also be used in offline operation for analyzing values recorded during a test drive. Furthermore, the method 100 can permanently run in owners' vehicles and transmit data periodically or in real-time to a back-end and/or central computer for anonymous evaluation.

By indicating a desired value, e.g. based on calculations, in particular vehicle simulations, or based on reference vehicles, target values or target value functions can preferably be specified, 113, to which the determined characteristic value can be compared, 114. A generally applicable evaluation of the energy efficiency based on the comparison 114 ultimately issues 115 therefrom.

Particularly preferentially, the correlation between a characteristic value and a target value is portrayed in a mathematical function so that appropriate parameter input into the function will return the evaluation of the energy efficiency as the result of a calculation.

A simple function for calculating a characteristic value KW can be portrayed as follows, whereby the value of the cᵢ factors are subject to the respectively determined driving state:

KW=c₂·parameter₁+c₂·parameter₂

Calculating an evaluation can accordingly follow, whereby the cᵢ factors in this case furthermore depend on a corresponding target value function serving as an evaluation reference.

Both the generally applicable characteristic value as well as the generally applicable evaluation of the efficiency of the vehicle 2 are suitable variables for replacing the consumption standards determined on the basis of fixed driving cycles like the NEDC (New European Driving Cycle) or WLTP (Worldwide Harmonized Light Vehicles Test Procedures) as used to date.

Preferably, the environmental topography of the vehicle 2 can also be incorporated in the characteristic value or the evaluation. Whether or not the operation strategy of a vehicle 2 takes accounts of the terrain, e.g. the route ahead of the vehicle, can hereby be factored in so as to achieve the most favorable energy efficiency possible. The operation strategy of a vehicle 2 could thus for example provide for an electrical energy storage device 15 or a compressed air energy storage device 15 being fully charged over a steep descent so that the respective energy storage device 15 can release this energy again on a subsequent ascent. A laser or lidar system on the vehicle can be used to determine the topography, although the topography can also be determined by means of a GPS system and cartographical material available to the vehicle driver and/or the vehicle 2.

As noted at the outset, further preferably employed is also a categorization of the system integration of the complete vehicle. The energy efficiency is thereby not only made independent of a specific driving cycle but the energy efficiency can be determined just for individual systems or functions of the vehicle 2 alone. This is preferably achieved by determining an energy consumption of at least one apparatus A, particularly an auxiliary equipment unit 16 of the at least one drive device 3, steering system, powertrain or any other system, component or structural element of the vehicle.

Such a categorization according is exemplarily depicted in FIG. 4. The vehicle 2 can hereby be subdivided into modules such as e.g. powertrain and body. The individual modules can in turn be subdivided into components and structural elements. Components of the powertrain are hereby in particular, as depicted, an internal combustion engine (ICE), an electric motor, a transmission and their electrical controls. An apparatus A can be formed by a module, a component or also by a structural element.

When the system 1 or a user specifies which apparatus A is to be left out of the consideration when determining the at least one characteristic value or evaluation 111, its energy consumption can then be determined and subtracted from the total energy consumption as a component to be disregarded.

By so doing, individual apparatus A can be selectively excluded from the energy efficiency determination for the vehicle 2, whereby a differentiation can hereby be made between those apparatus A necessary for the vehicle's drive operation and those apparatus A which perform functions unrelated to the drive operation. The former apparatus A are, for example, the steering system and the braking system but also the engine coolant pump. The latter apparatus A are, for example, the air conditioning or also the infotainment system.

In order to determine the energy consumption of an apparatus A which partially consumes energy and partially releases the energy such as, for example, an internal combustion engine or also an electric motor or the transmission, it may be necessary in the determining of the energy consumption to determine both that energy provided to the respective apparatus A as well as that energy which the apparatus A releases again; i.e. an energy balance must be established with respect to apparatus A. As regards a drive device 3 of the vehicle 2, such supplied energy E(in) is defined by the supplied amount of fuel or also the carbon emission of the internal combustion engine; in the case of an electric motor, by the consumption of electrical energy. With respect to internal combustion engines, the supplied energy E(in) may possibly also include energy supplied with regard to additional electric motors, so-called auxiliary equipment.

The output energy E(out) of the drive device, which is supplied for propulsion and for further auxiliary equipment in the vehicle, can be measured on the shaft by way of rotational speed and torque. If only the efficiency of the combustion process by itself is to be determined, it also needs to be considered that the energy supplied to the internal combustion engine from electric motors via auxiliary equipment be offset again at the end from the energy obtained from the combustion by the bypassing of the energy storage device 15 as applicable.

FIG. 5 relates to a representation of the procedural steps of a method for analyzing an operating behavior of a vehicle 2. The depicted method 200 substantially corresponds to the method for analyzing an energy efficiency of a vehicle 2 as per FIG. 2, whereby the parameters of the first data set not only characterize the energy consumption but also an emission, driveability and an NVH level of the vehicle. In a further procedural step 206, an energy efficiency value, an emission value, a driveability value and an NVH comfort value is in each case determined for the respective driving state from the information of the first data set, the second data set and the third data set. In a further procedural step 207, a relevance of the respective driving state is determined in each case for the energy efficiency, emission, driveability and NVH level criterion.

Identifying the relevance of individual driving states by determining the events within the driving states which influence the respective criterion, such as e.g. a steep rise in emissions or a drop in emissions for the emission criterion, enables conflicting objectives to be identified when optimizing in respect of the various criterion crucial to user perception. The individual values for energy efficiency, emission, driveability and NVH comfort are weighted, 210, whereby the relevance of a driving state and/or a driving element to the respective criteria is hereby considered. Based on these weighted values for the criteria and the respectively given driving state, a total characteristic value is determined, 211, on the basis of which conflicting objectives between the individual criteria can be resolved by means of optimization.

The procedural steps of the advantageous embodiment, which substantially correspond to the method for analyzing the energy efficiency of a vehicle, are likewise depicted in FIG. 5 by dotted-line blocks.

It is obvious to one skilled in the art that there is no mandatory sequence to the individual procedural steps of the inventive method as depicted. For example, the data sets (201, 202, 203) can thus be acquired simultaneously or also in a different sequence than as shown in FIG. 5.

FIG. 6 shows a partly schematic diagram of the result of an analysis of real-drive measurements, in which respectively relevant events are identified for the emission, energy efficiency, driveability and NVH level criterion on the basis of parameters which characterize these criterion and on the basis of the driving elements as driven, particularly driving states.

A driving profile of a vehicle 2 is again depicted in the upper part of the diagram based on the third parameter of speed over elapsed time. In the lower part, those driving elements and/or driving states identified as being relevant to the respective emission, efficiency, driveability and NVH level criterion are respectively indicated as bright areas.

It becomes evident from a consideration of the results that while there are single driving elements which are relevant to the overall evaluation only in terms of one optimization variable, as a general rule, the same driving elements are material to emission, efficiency, driveability and NVH comfort. The conflicting objectives within the evaluation must then be resolved by means of these interdependences. The driving elements shown thereby preferably correspond to a driving state or a succession of identical or different driving states.

The identification of result-relevant driving elements requires specification of corresponding target values for these driving elements and comparison to the actual values measured in each case. The target values for the individual criteria are thereby generated in different ways:

Energy efficiency and emission: The target value specification is preferably realized as depicted above for the efficiency. The target values relative to these criteria are preferably based solely on an evaluation of physical parameters.

Driveability and NVH comfort: Target value specification here is realized on the basis of objectified subjective driving perceptions and the specifying of a desired vehicle characteristic. Subjective driving perceptions are preferably objectified on the basis of discrete mathematical correlations; in the simplest case by comparison to a reference vehicle, In many cases, however, human perceptions via neural networks need to be correlated with physically measurable variables.

The preferable identification of relevant events applicable to the evaluation of multiple criteria can reliably identify bottlenecks in the optimization of a vehicle.

When evaluating a vehicle's development status, however, preferably of interest is not only comparison to the ideal characteristic values and processes normally generated in the concept phase of overall development but rather also the positioning within a specific benchmark distribution range. This is particularly of significance for vehicle analyses in which the basic data necessary for target value calculation is not complete. To produce such a database, tests can be run on the respectively most current vehicles.

The actual optimization preferably results from incorporating the single result-relevant events into the respectively best-suited development environment. For single events primarily relating to only one criterion, the optimization takes place in many cases directly in the vehicle in direct interaction with an automated online evaluation (e.g. compensating specific driveability failings). For those single events in which there are pronounced conflicting objective relationships between the different evaluation variables (e.g. efficiency, emissions, driveability, NVH level, etc.), it is expedient to preferably reproduce the relevant single events on the XiL (hardware-in-the-loop), motor and/or powertrain test bed. The reproducible operation as per the teaching of the invention allows efficient single driving element development, whereby there is not only an isolated optimization of a single variable but rather an optimizing of the conflicting objectives of the individual criteria. In addition, given a concurrently running complete vehicle model, the effects on the entire “vehicle” system can also be directly assessed.

A comparison to a real-drive driving element library (benchmark data) preferably enables detailed classification in the competitive environment. This preferably direct assessability enables a fast and accurate response and thus a greater degree of process flexibility.

The driving element consideration based on the events allows both efficient calibration capability as well as also an accurate virtual identification of optimally adapted drive architectures. This also enables the generating of a refined developmental topography map in which the relevant developmental tasks (both technical as well as subjective variables) are marked.

Preferably, a comprehensive real-drive driving element database having corresponding statistics on result-relevant single events as well as a segmented consideration of relevant driving profiles is provided, by means of which important result-relevant task definitions can be accurately addressed not only in the calibration process but also in the early conceptual phase of a powertrain or of vehicle development respectively.

Driving states which are critical to the energy efficiency or for further criteria are preferably indicated on the basis of the physical parameters for the driving state. Based on this representation, driving states which were for example determined during real-world driving with a real vehicle can be reconstructed on the vehicle roller rig, on the powertrain test bed, on the dynamic dynamometer or in an XiL-simulated environment. This enables critical driving states to be tested on the test bed, for example for the purpose of solving conflicting objectives between different criteria.

Further aspects of the invention are described in the following example embodiments referencing FIGS. 7 to 18.

Tightened legal requirements (e.g. CO2, WLTP, RDE) and increased customer requirements (“positive driving experience”) as well as the inclusion of all the relevant environmental information (“connected powertrain”) result in drastically increased complexity and increasing variation diversity for future drive systems. The development challenges are thereby even further intensified by shortened model life cycles and the additional increased inclusion of actual customer driving (“real-world driving”).

Efficient development under expanded “real world” boundary conditions such as for example the expanding of the previous synthesized test cycles to real operation with random driving cycles firstly requires objectifying subjective variables (e.g. driving experience) but also reproducibly determining complex, stochastically influenced characteristic values (e.g. real-drive emissions). To this end, random driving profiles are divided into small, reproducible and assessable driving elements and the relevant trade-off relationships (e.g. driveability, noise perception, efficiency, emission) optimized in the single element. An intelligent “event finder” thereby allows selectively concentrating on those driving elements which have substantial influence on the total result. Additionally, a “real-drive maneuver library” generated therefrom coupled with a comprehensive complete vehicle model forms an essential foundation for positioning individual development tasks in the respectively best-suited developmental environments and thus increasingly in the virtual world.

However, a shortening of the overall total vehicle development process requires not only intensified front-loading during the development of the individual subsystems but also heightened all-encompassing activity in mixed virtual/real developmental environments. The step from digital mockup (DMU) to functional mockup (FMU) and consistent evaluation from the entire vehicle perspective contribute substantially to even being able to control the complexity of future drives within short development times in the first place. With the integrated open development platform IOPD and the expanded evaluation platform AVL-DRIVE V4.0, AVL has hereby created substantial tool and methodology modules.

### 1. Challenges in Drive Development

The greatest stimuli for advancing passenger car drive systems over the medium and long term will come both from legislation as well as from the end customer.

The significant reduction of CO2 fleet emissions under the threat of penalty fines, stricter test procedures (WLTP) and the additional limiting of harmful emissions in real customer vehicle operation (real driving emission) represent significant tightening of the legal statutory constraints and create substantial additional expenditures for the vehicle development process. On the customer's side, the matter of “Total Cost of Ownership” on the one hand is taking on importance while on the other hand, purely subjective criteria like social trends and social acceptance, etc., but also particularly a “positive driving experience” are having increasing influence on the most critical of purchase factors. Thus, the focus of the representation is expanded from purely technical objective values such as performance and fuel consumption to the satisfying of a positive subjective customer experience—the “experience car” thereby goes far beyond the powertrain performance. The consumers thereby perceive the properties and value of the vehicle such as its styling, ergonomics, operability, infotainment and assistance systems, sense of safety, driving comfort, agility and driveability in a holistic context and as the overall vehicle performance.

Thus, actual real-world driving has become particularly important in the development of new vehicle systems: not only real-world emissions and consumption but also the positive driving experience of the customer is a crucial objective criterion. Subjective valuation criteria are, however, subject to more than just rapid changes. New trends, individual requirements and new technologies yield significant unpredictability in a highly dynamic market [1]. The response to this situation can only be extremely rapid reactivity in product configuration and development. The short model cycles already common throughout the IT field today on an order of just months are having increased impact on the infotainment and assistance systems in automobile development. Thus, we in the automotive field also must adapt to substantially shortened model change cycles and/or upgradable solutions as well as introduce flexible development methods. A sensible technical solution here certainly lies in expanded modular design principles which enable highly diversified solutions by means of software. Flexible, adaptive and test-based methods of model-based development will thereby be of assistance.

With respect to the purely technical aspects, certainly CO2 legislation represents the most significant technology driver. Future CO2 and/or consumption fleet limits are converging worldwide into continually reducing levels. This requires on the one hand complex drive systems with ultra-flexible components, on the other, however, also calls for increased individualized adapting to the most diverse boundary conditions and results in multi-dimensional diversification of drive systems (different energy sources, different degrees of electrification, variant diversity, etc.).

In the future, integration of the powertrain into the entire relevant vehicle environment (“connected powertrain”) will additionally allow optimum adapting of operating strategies to actual traffic and environmental conditions. The wealth of information from vehicle infotainment and assistance systems to C2X communication allows the precalculating of numerous scenarios and thus tremendously expands the optimization horizon. The various degrees of freedom of future drive systems can thus be used to a substantially greater extent to reduce energy consumption. However, this requires highly complex operating strategies with drastically increased development, calibration and above all validation expenditure.

In addition to the reliable control of such increasing drive system complexity, future RDE legislation represents a further, very crucial influence on development methodology. This is characterized by the expansion of the synthesized test cycle to randomized actual operation with a bewildering range of different driving states and boundary conditions.

From the customer's perspective, however, real-world driving encompasses substantially more than just RDE:
Positive driving experience—Driveability/Comfort/Agility/Operability
Absolute functional safety
Highest efficiency/minimum consumption
Confidence in driver assistance systems
High reliability/durability

### 2. Driving Element-Oriented Approach in the Development Process

The transition from precise testing reproducibility with clearly defined cycles and fixed evaluation variables to real-world driving evaluations with statistical randomness as well as consideration of subjectively perceived driving experiences represents a substantial upheaval and thereby necessitates both new developmental approaches as well as new development environments. The substantial fundamental requirements thereby are:
The objectification of subjective variables (e.g. driving experience): In terms of the objectification of subjectively perceived noise and driveability, AVL has been gathering practical experience for many decades and developing the corresponding developmental tools—thus, for example AVL-DRIVE [2] is well on its way to becoming a widely accepted tool for evaluating driveability.
Reliably reproducible determination of complex stochastically influenced characteristic values (e.g. real-drive emission): Subdividing such complex driving profiles into reproducible and assessable segments—the driving elements—categorizing them and statistically factoring in the influence on the integral characteristic value is a highly practicable approach. This can be seen analogously to the discretization of other task definitions such as e.g. fatigue analyses or process simulation. The value of these elements is thereby dictated by the demand for reproducible evaluability. Subjective human perceptions hereby also become the reference for other evaluation parameters such as consumption, emissions, etc.
However, the truly crucial step is the ability to identify those single elements from the plurality of single elements which have significant relevance for the overall result.

AVL has successfully used such a method for years within the realm of driveability development (AVL-DRIVE). A random real-world driving profile is thereby divided into defined single elements which are then allocated to approximately 100 individual categories and separately evaluated and statistically assessed according to approximately 400 specific evaluation criteria.

With comparably few adjustments, this method of using categorizable driving segments can be employed not only for evaluating driveability and noise level under actual conditions, but also for emissions, efficiency and subsequently also lateral dynamic variables all the way up to the evaluation of driving assistance systems [3].

In assessing the results of real-world measurements, it becomes evident that while there are single driving elements which are relevant to the overall evaluation only in terms of one optimization variable, as a general rule, the same driving elements are material to emission, efficiency, driveability and noise level. The conflicting objectives within a single driving element must then be resolved by means of these interdependences.

An intelligent “event finder” can thereby reliably identify “bottlenecks.” Identification of these “events”—thus of result-relevant driving elements—online specification of corresponding target values for these driving elements and comparison to the actual values measured in each case. The target values for the individual evaluation variables are thereby generated in different ways:
Efficiency: The online target value calculation is realized in a complete vehicle model synchronized to the vehicle measurements based on the measured vehicle lateral dynamics and a factoring in of the current topography as well as other driving resistances. The vehicle model not only contains the entire hardware configuration but also the corresponding operating strategies. A balancing of all energy flows and energy stores is of course thereby necessary.
Emissions: In principle, the target value specification could be realized analogously to the “Efficiency” evaluation variable. With respect to the forthcoming RDE legislation, however, it makes more sense to effect the evaluation pursuant to the RDE regulations to be stipulated in the future legislation.
Driveability: Target value specification here is realized on the basis of objectified subjective driving perceptions and the specifying of a desired vehicle characteristic pursuant to AVL-DRIVE-developed classifications [2]. To objectify subjective driving perceptions, human perceptions via neural networks thereby need to be repeatedly correlated with physically measurable variables.
NVH: Similarly to the driveability, target value specification here is effected on the basis of the objectified subjective perception of noise and specification of the desired acoustic characteristics (e.g. AVL-VOICE [4]).

For evaluating the level of development of a vehicle, however, of interest is not only a comparison to the typically generated ideal values and processes in the concept phase of overall development but also the positioning within a specific benchmark distribution range. This is particularly of significance for vehicle analyses in which the basic data necessary for target value calculation is not complete. So as to ensure sufficient statistical relevance of current benchmark data (real-drive maneuver library), AVL conducted, e.g. just in 2014 alone, approximately 150 benchmark tests on the respectively most current vehicles.

The actual optimization results from incorporating the single result-relevant events into the respectively best-suited development environment. For single events primarily relating to only one evaluation variable, the optimization takes place in many cases directly in the vehicle in direct interaction with an automated online evaluation (e.g. compensating specific driveability failings).

For those single events in which there are pronounced conflicting objective relationships between the different evaluation variables (e.g. efficiency, emissions, driveability, etc.), it is expedient to reproduce the relevant single events on the XiL, motor and/or powertrain test bed. The reproducible operation here allows efficient single driving element development, whereby there is not only an isolated optimization of a single variable but rather an optimizing of the trade-offs (typically emission/efficiency/driveability/noise). In addition, given a concurrently running complete vehicle model, the effects on the entire “vehicle” system can also be directly assessed. Moreover, the comparison to a “real-drive maneuver library” (benchmark data) allows detailed classification in the competitive environment. This direct assessability enables a fast and accurate response and thus a greater degree of process flexibility.

The driving element consideration based on an intelligent event finder allows both efficient calibration capability as well as also an accurate virtual identification of optimally adapted drive architectures. This also enables the generating of a refined developmental topography map in which the relevant developmental tasks (both technical as well as subjective variables) are marked.

The availability of a comprehensive maneuver database with corresponding statistics on result-relevant single events as well as a segmented consideration of relevant driving profiles is thus essential not only in the calibration process but also during the early conceptual phase of powertrain development to accurately address important result-relevant task definitions.

### 3. Simultaneous Control of Developmental Procedures on Multiple Development Levels

In addition to segmenting complex driving profiles into small, assessable single elements (vertical segmenting), categorizing the system integration of the complete vehicle into different system and component levels (horizontal categorization) is also a reliable basis for efficient development processes.

The vehicle-internal data and regulatory network/environment integration (“connected powertrain”) results in an additional superordinate system level, the “traffic level.”

The segmenting of driving profiles originally began at the vehicle module level with the optimizing of the longitudinal dynamics behavior of the powertrain (driveability optimization) and was then broken down to the level of the individual powertrain modules (e.g. engine, transmission, etc.).

However, a comprehensive acoustic and comfort evaluation already requires segmenting to the vehicle level. Operating at the vehicle level is also necessary in the development of the lateral dynamics-relevant functions (such as e.g. chassis tuning through to stability control [5]).

For the objectified evaluation of driver assistance systems (ADAS—Advanced Driver Assistance Systems), all the relevant environmental information needs to be integrated and thus the highest system level (“traffic level”) included.

Basically similar requirements with respect to the segmenting of complex driving profiles and the objectification of subjective variables are also applicable to most optimizations on the vehicle or traffic level. The tools already employed in the evaluation of the powertrain longitudinal dynamics can thereby also be used for the optimization of lateral dynamics functions [2]. Since, however, the segmentation of the driving profiles differ for longitudinal and lateral dynamic aspects (with the exception of the stability control), there are few trade-off relationships, a further separate treatment of longitudinal and lateral dynamic tasks with respect to controllable developmental complexity seems to be expedient at present. In contrast, there are already comprehensively optimized longitudinal and lateral dynamic task definitions in motorsport racing today.

Although the essential subsystems at the vehicle module level (e.g. powertrain, body and chassis, electrics and electronics) are developed alongside their own processes, the overall vehicle development process is the dominant reference variable for all the other system developments. The overall vehicle development thus synchronizes all individual developmental tasks and also controls the structure of software and hardware integration levels (concept and prototype vehicles) with predefined functions. Complicating matters, however, is the fact that the developmental processes of the individual subsystems generally adhere to different time frames.

Hence, the common synchronization points within the overall vehicle development process (integration levels 1 to X) not only require working on a solely virtual or a solely real basis but also increasingly in mixed virtual/real development environments.

A key to controlling the complexity of the drive concepts of today and of the future is the early functional integration of the subsystems into an overall complete system perhaps provided in its entirety, partially or even only virtually (FIG. 4). Today's well-established, purely actual integration level process (with actual hardware and software) will also be expanded in the future in line with front-loading to earlier development phases in purely virtual and combined virtual/real development environments.

Developments at the module or component level can thus then also be analyzed and developed in a total-vehicle context in the absence of complete vehicle prototypes. Complex interrelationships can thereby be evaluated and controlled in purely virtual or combined virtual/real developmental environments at an early stage and thereby facilitate the transition from digital mockup (DMU) to functional mockup (FMU).

Although the final validation of the functions will continue to occur in the vehicle, increased front-loading will also thereby be employed. With the new possibilities of a combined virtual/real development process, the steep rise in the number of development subtasks cannot only be efficiently managed but already initiated in the earlier development phases. Only by so doing will the complexity of drive development even be able to be controlled at all in the future.

Hence, over the entire development process, it is necessary to have an evaluation from the perspective of the overall vehicle subject to the relevant operating conditions (driver+road+environment). Virtual and real-world testing is therefore coupled by way of a parallel complete vehicle model.

Both the functional development as well as also the validation of the combustion engine are run on stationary and dynamic engine test beds. The development of engine control and corresponding software functionalities including diagnostic functions is most appropriately transferred to XiL test rigs. The parallel virtual complete vehicle model (entire vehicle) with driving resistances, structure, axles, suspension, steering, braking system allows a continuous evaluation for achieving objectives in terms of vehicle consumption, emission and dynamics.

Particularly for the tuning, calibrating and validating of hybrid functions, the provision of combustion engine, transmission and electric motor hardware on the powertrain test bed constitutes a most efficient development environment. On the other hand, all the development tasks not requiring the full powertrain hardware (e.g. development/calibration of diagnostic functions) are processed in parallel in an XiL environment.

Depending on the task definition and available vehicle hardware, testing is run on the powertrain test bed with or without vehicle, on the rolling test rig as well as on the road in assembly carriers or in the vehicle prototype respectively. Since test conditions (driver, distance, load, wind, altitude, climate, etc.) as well as the parameters of the complete vehicle (driving resistances, structure, axles, suspension, steering, etc.—variant simulations) can change relatively rapidly on the powertrain test bed, it is often advantageous to increase both the development as well as the validation of complex systems (e.g. a completely new hybrid system) on the powertrain test bed even when the entire hardware including vehicle is available.

The allocating of tasks to the respectively best-suited development environment is gaining great important particularly in the field of validation. The combination of dramatically increasing system complexity and shortened development times requires intensified front-loading not only for the functional development but in particular also for the functional validation. Complete system validation is thereby no longer exclusively hardware-based but rather occurs in widely diverse combinations of real and virtual components in mixed virtual/real development environments (e.g. “virtual road on the test bed—virtual route—virtual driver”).

An efficient and comprehensive validating of functional safety is crucial in the case of complex systems. The basis for the validation thereby represents a precisely generated collective of relevant test sequences which must provide feasible operational and misuse scenarios as well as comprehensive FMEAs (Failure Mode and Effects Analysis) by means of detailed system analysis, evaluation and classification. A high degree of systematization and automation thereby enables potentially critical operating states to be tested in substantially shorter time than of conventional road tests.

Pre-selecting these potentially critical states of course entails the risk of the test program only providing answers to explicitly posed questions while not addressing other points of risk. This risk will be lessened in the future by additional validating profiles generated from the maneuver database.

4. From DMU (Digital Mock-Up) to FMU (Functional Mock-Up) or from the “ToolChain” for the Traditional Development Procedure to the “ToolNetwork” for an Integral, Multi-Level Development Process

In the actual development process, the parallelism of virtual, numerical component models and actually available hardware development stages already today require in many cases a “leap” between virtual and “real” experiments and will to a much greater degree in the future, whereby the “real” experiments of today in many cases already contain simulations. For flexible development, simulation and hardware have to mesh seamlessly and be interchangeable. In many cases, the development tool consistency required for that is not yet in place. The AVL-IODP (Integrated Open Development Platform) consistently displays this consistency throughout the entire development environment.

Substantial aspects of the systematic application of an integrated consistent development platform, which is moreover open to the most varied tools, are:
Consistent processes and methods allow a “front loading” of development tasks which to date have largely been performed for example in road tests, in earlier development phases, on the motor or powertrain test bed—in extreme cases, even in a purely virtual simulation environment (office simulation). Thus, an engine can for example be precalibrated in a combined real/virtual development environment with comparable quality of results substantially more rapidly than just by road testing alone.
Simulation model consistency: Simulation models prepared in early development phases can also be reused in subsequent development phases and environments. These simulation models supplement (as virtual components) the hardware/development environments (i.e. test beds) by a mixed virtual/real development environment able to represent interactions at the complete vehicle level.
Consistent comparability of virtual and real tests by means of consistent data management and seamless model and method consistency. Results generated by means of simulation must on the one hand be consistent with the corresponding real-world tests and, on the other, also allow further development of the simulation models on the basis of the test results over the course of the development process. The feasibility of such continuous, consistent reconciliation between the virtual, real and combined virtual/real world is the prerequisite for a flexible modern development process.
Consistent model and test parameterization: Particularly during controller calibration, a plurality of input parameters such as e.g. environmental conditions, driving maneuvers, calibration data sets, etc. need to be managed. In order to be able to later compare the results between virtual and real testing, the input data sets also need to be comparably and consistently provided in the process.
Consistent embedding into existing process environments: It is of course necessary to be able to integrate continually new and/or improved development tools into existing processes and process environments. Such a development platform must therefore be open in the sense of, on the one hand, the integration of virtual, real and combined virtual/real tools and, on the other, the data management. The preferential aim is a “bottom-up approach” which also allows the integration of existing tools, thereby building upon existing know-how and well-established tools.

This IODP development platform is thus the basis for a consistent, model-based development process and broadens conventional toolchains into an integrated and consistent network: “From a sequential toolchain to a tool network.” In this platform, virtual and real drive components can be integrated at the complete vehicle level at any time in the development process and the respectively suitable development environments configured. This tool network thus also represents a tool kit for the most flexible development process possible.

Consequently, integrating the development tools also requires an integrated evaluation platform in which the development result can be evaluated not only at the component and system level but also at the complete vehicle level on an ongoing basis.

Driveability evaluation with AVL-DRIVE has represented a first approach toward a comprehensive evaluation platform for many years now. The structure of this evaluation platform allows a consistent driveability evaluation to be conducted with all the relevant tools—from office simulation to real-world vehicle road test. The next expansion stages of AVL DRIVE-V 4.0 expand this evaluation platform by
Emission evaluation pursuant to RDE legislative guidelines
Efficiency evaluation with online ideal target value calculation including benchmark environment positioning
Subjective noise perception evaluation

This thus renders possible a consistent evaluation of the most essential evaluation parameters, from simulation to a motor/drive test bed and roller rig to the road test.

### 5. Outlook

The systematic continuation of these model-based development methods with driving element-based evaluation will in the future also enable selective development of Advanced Driver Assistance Systems (ADAS), automated driving as well as the “connected powertrain” in a “connected vehicle” network while still in a virtual environment and thus the efficient implementing of a comprehensive front-loading approach [2]. In enhancing the test bed and simulation structure, additional route, infrastructure, traffic objects and corresponding environmental sensors such as radar, lidar, ultrasonics, 2D and 3D cameras hereby need to be simulated on the powertrain test bed as complete vehicle and environment. So that map-based functions, for example such as for navigation system-based anticipatory energy management (e.g. e-Horizon) will function in the test bed booth, GPS signals of any position on earth can additionally be emulated and transmitted.

The depicted configuration ultimately allows the reproducible evaluating of functional safety, the correct functions as well as performance in terms of emission, consumption, mileage, safety and comfort characteristics in different driving maneuvers and traffic scenarios for the entire system as well as for the subjective driver perceptions.

Due to the rising complexity of the development tasks and the necessity in the future of having to manage comprehensive tool networks instead of toolchains, it will be increasingly difficult for the development engineer to make optimum use of all these tools and properly evaluate the responses and/or results from virtual and real tests and incorporate them into the further development. It will thus be necessary to also make the tools themselves even more “intelligent” as “Smart Cyber-Physical Systems.” Such “intelligent” tools will better support the engineer in his work. These tools will know the test object's physical processes as well as the interrelationships between the development tasks and will thereby understand the measurement data; from automatic data plausibility to the efficient analysis and intelligent interpretation of large volumes of data. Nevertheless, these increasingly complex tasks in comprehensive development environments also require generic developer operation the “networked development engineer”—who can, among other things, also move quickly between different system levels.

### LITERATURE

[1] List, H. O.: “Künftige Antriebssysteme im rasch veränderlichen globalen Umfeld”; 30th International Vienna Motor Symposium, May 7-8, 2009
[2] List, H.; Schoeggl, P.: “Objective Evaluation of Vehicle Driveability”, SAE Technical Paper 980204, 1998, doi: 10.4271/980204
[3] Fischer, R; Küpper, K.; Schöggl, P.: “Antriebsoptimierung durch Fahrzeug-vernetzung”; 35th International Vienna Motor Symposium, May 8-9, 2014
[4] Biermayer, W.; Thomann, S.; Brandi, F.: “A Software Tool for Noise Quality and Brand Sound Development”, SAE 01NVC-138, Traverse City, Apr. 30-May 3, 2001
[5] Schrauf, M.; Schöggl, P.: “Objektivierung der Driveability von Automatisier-tem/Autonomem Fahren”, 2013 AVL Engine & Environment Conference, Sep. 5-6, 2013, Graz
[6] Hirose, T.; Sugiura, T.; Weck, T; Pfister, F.: “How To Achieve Real-Life Test Coverage Of Advanced 4-Wheel-Drive Hybrid Applications”, CTI Berlin, 2013

### LIST OF REFERENCE NUMERALS

system 1
vehicle 2
drive device 3
first device 4
second device 5
third device 6
first comparison device 7
allocation device 8
processing device 9
fourth device 10
second comparison device 11
output device 12
selection device 13
fifth device 14a, 14b, 14c, 14d
energy storage device 15
steering actuator 16
steering control 17
radial tire 18a, 18b, 18c, 18d
transmission 19
steering wheel input/steering wheel 20
differential 21
exhaust gas treatment 22
exhaust analysis device 23
exhaust system 24
data storage unit 25

1. A system for analyzing an energy efficiency of a vehicle having at least one drive device which is configured to generate mechanical propulsion by the conversion of energy, comprising:
a first device, particularly a sensor, designed to acquire a first data set of at least one first parameter suited to characterizing an energy consumption of the vehicle;
a second device, particularly a sensor, designed to acquire a second data set of at least one second parameter suited to characterizing a driving resistance which the vehicle overcomes;
a third device, particularly a sensor, designed to acquire a third data set of at least one third parameter suited to characterizing at least one driving state of the vehicle,
a first comparison device, particularly part of a data processing device, designed to compare the values of the third data set to predefined parameter ranges corresponding to at least one driving state;
an allocation device, particularly part of a data processing device, designed to allocate the values of the first data set and the values of the second data set to the respectively present at least one driving state; and
a processing device, particularly part of a data processing device, designed to determine at least one characteristic value characterizing the energy efficiency of the vehicle on the basis of the first data set and the second data set as a function of the at least one driving state.

2. The system according to claim 1, further comprising:
a fourth device, particularly an interface, designed to acquire a target value for the at least one characteristic value, particularly on the basis of a vehicle model or a reference vehicle;
a second comparison device, particularly part of a data processing device, designed to compare the characteristic value to the target value for the determining of an evaluation; and
an output device particularly a display, designed to output the evaluation on the basis of the comparison.

3. The system according to claim 1, further comprising:
a selection device, particularly part of a data processing device, designed to appoint at least one apparatus, the energy consumption of which is not factored into the determining of the at least one characteristic value for the energy efficiency of the vehicle;
and a fifth device, particularly a sensor, designed to acquire a further second parameter characterizing the energy consumption of the at least one apparatus, wherein the processing device is further designed to adjust the energy consumption of the vehicle by the energy consumption of the at least one apparatus.

4. The system according to claim 1, further comprising a storage devices designed to store a succession of driving states and that the processing device is further designed to factor in the succession of driving states when determining the characteristic value.

5. The system according to claim 1, wherein the processing device is further designed to adjust an allocation of the values of the first data set and the second data set to the at least one predefined driving state so as to take into account signal propagation delay and/or elapsed time from at least one measuring medium for acquiring the respective data set to a sensor.

6. A method for the analysis of an energy efficiency of a vehicle having at least one drive device which is configured to generate mechanical propulsion by the conversion of energy, comprising:
acquiring a first data set of at least one first parameter which is suited to characterizing an energy consumption of the vehicle;
acquiring a second data set of at least one second parameter which is suited to characterizing a driving resistance which the vehicle overcomes;
acquiring a third data set of at least one third parameter which is suited to characterizing at least one driving state;
comparing the values of the third data set to predefined parameter ranges corresponding to at least one driving state;
allocating the values of the first data set and the values of the second data set to the respectively present at least one driving state; and
determining at least one characteristic value characterizing the energy efficiency of the vehicle on the basis of the first data set and the second data set as a function of the at least one driving state.

7. The method according to claim 6, further comprising the following steps:
acquiring a target value for the at least one characteristic value, particularly on the basis of a vehicle model or a reference vehicle;
comparing the characteristic value to the target value for the determining of an evaluation; and
outputting the evaluation on the basis of the comparison.

8. The method according to claim 6, wherein the at least one second parameter is further suited to characterizing a topography of the surroundings of the vehicle.

9. The method according to claim 8, wherein the at least one second parameter further characterizes an operating state and/or an energy consumption of at least one apparatus of the vehicle, particularly an auxiliary equipment unit, the at least one drive device, a steering system or a powertrain and/or that the method comprises the further procedural steps:
appointing the at least one apparatus, the energy consumption of which is not to be factored in when determining the at least one characteristic value on the energy efficiency of the vehicle; and
adjusting the energy consumption of the vehicle by the energy consumption of the at least one apparatus.

10. The method according to claim 9, wherein that the at least one apparatus is necessary to the drive operation of the vehicle or fulfills a function independent of the drive operation.

11. The method according to claim 6, wherein the at least one drive device is an internal combustion engine or an electric motor having a fuel cell system and the first parameter indicates at least one emission of the internal combustion engine or fuel cell system.

12. The method according to claim 7, wherein the at least one first parameter is additionally suited to characterizing an emission, a driveability and/or an NVH comfort level of the vehicle and that the method further comprises the following procedural step:
selecting at least one operating mode of the vehicle on which the evaluation additionally depends from the following group of operating modes:
efficiency-oriented operating mode reduced-emission operating mode, driveability-oriented operating mode, NVH-optimized operating mode.

13. A method for analyzing a vehicle operating behavior of a vehicle having at least one drive device which is configured to generate mechanical propulsion by the conversion of energy, comprising the following procedural steps:
acquiring a first data set of at least one first parameter which is suited to characterizing an energy consumption, an emission, a driveability and a NVH comfort level of the vehicle;
acquiring a second data set of at least one second parameter which is suited to characterizing a driving resistance which the vehicle overcomes;
acquiring a third data set of at least one third parameter which is suited to characterizing at least one driving state;
comparing the values of the third data set to predefined parameter ranges corresponding to at least one driving state;
allocating the values of the first data set and the values of the second data set to the respective driving state;
identifying an energy efficiency value, an emission value, a driveability value and an NVH comfort value for the respective driving state;
determining the relevance of the respective driving state for the energy efficiency, the emission, the driveability and the NVH comfort level of the vehicle;
weighting the energy efficiency value, the emission value, the driveability value and the NVH comfort value on the basis of the relevance;
determining at least one characteristic value characterizing the vehicle operating behavior of the vehicle on the basis of the weighted energy efficiency value, the weighted emission value, the weighted driveability value and the weighted NVH comfort value as a function of the at least one driving state.

14. The method according to claim 13, wherein same comprises the further following procedural steps:
acquiring a target value for the at least one characteristic value, particularly on the basis of a vehicle model or a reference vehicle;
comparing the characteristic value to the target value for the determining of an evaluation; and
outputting the evaluation on the basis of the comparison.

15. The method according to claim 6, wherein the procedural steps are continued until the third data set spans a plurality of different driving states.

16. The method according to claim 6, further comprising a step of:
determining the succession of driving states, wherein the succession of driving states is factored into the determination of the characteristic value.

17. The method according to claim 6, wherein the values of the first data set and/or the second data set are integrated over the duration of the respective driving state.

18. The method according to claim 6, wherein the values from a plurality of third data sets for a same type of driving state are consolidated for the determining of the at least one characteristic value.

19. The method according to claim 6, further comprising the following step:
adjusting an allocation of the values of the first data set and the second data set to the at least one predefined driving state so as to take into account a signal propagation delay and/or elapsed time from at least one measuring medium for acquiring the respective data set to a sensor.

20. The method according to claim 6, wherein the parameter values of the data sets are acquired during a real-drive operation of the vehicle, wherein it is preferential for the real vehicle to travel an actual driving route selected pursuant to stochastic principles, more preferential for a real vehicle to travel an at least partly simulated route selected pursuant to stochastic principles, even further preferential for an at least partly simulated vehicle to travel an at least partly simulated route selected pursuant to stochastic principles, and most preferential for a simulated vehicle to travel a simulated route selected pursuant to stochastic principles.

21. A method in accordance with claim 6, wherein a characteristic value is only determined in the presence of at least one predefined driving state and/or when the first data set and/or the second data set meets predefined criteria.

22. A computer program having commands which, when executed by a computer, prompt same to perform a method in accordance with claim 6.

23. A computer-readable storage medium on which a computer program in accordance with claim 22 is stored.
